(19) United States
(12) Patent Application Publication
(10) Pub. No.: US 2020/0314380 A1
(43) Pub. Date: Oct. 1, 2020

(54) ONE-PIECE COMBINATION OF A TV HOUSING WITH REMOTE-CONTROL AND SMARTPHONE HOLDER

(71) Applicant: Carlos Alberto Sierra Murillo, Bogota (CO)

(72) Inventor: Carlos Alberto Sierra Murillo, Bogota (CO)

(21) Appl. No.: 16/371,160

(22) Filed: Apr. 1, 2019

(51) Int. Cl. H04N 5/65; H04N 5/655; H04N 5/645

(52) U.S. Cl. CPC H04N 5/65; H04N 5/645; H04N 5/655

(57) ABSTRACT

A combination of a TV housing with a remote-control and smartphone holder device including a television housing and at least one remote control holder and a smartphone holder. The device is a one-piece device.

### FIELD OF THE INVENTION

This invention relates to a remote-control and smartphone holder, and more specifically to a one-piece combination of a TV housing including remote-control and smartphone holder.

### BACKGROUND OF THE PRIOR ART

Actually, the use of remote controls and smartphones has increased considerably, as a typical home may have several remote controls and/or smartphones in order to operate the various electronic devices used for entertainment. Unfortunately, there is a problem when the remote controls and/or smartphones are misplaced.

The prior art shows several remote-control holders but none shows a smartphone holder. The prior art shows remote control holders that are mounted directly into the TV housing. These remote-control holders are secure to the TV housing by using brackets, screws, and other types of fastenings. Unfortunately, these holders may damage the TV housing.

The prior art also shows remote control holders that include a pouch system that hangs over the arm of a chair or sofa and has pouches or pockets within which the remote controls are placed. Unfortunately, these holders are not aesthetically pleasant and often do not go with the décor of the room.

In addition, the known remote controls are limited to the quantity, size, and type of the devices that they can hold.

Accordingly, there is a need to provide a remote-control and/or smartphone holder that does not damage the TV housing and/or change the appearance of the room.

### SUMMARY OF THE INVENTION

A combination of a TV housing with a remote-control and smartphone holder device including a television housing and at least one remote control holder and a smartphone holder. The device is a one-piece device.

In addition, the present invention refers to a combination of a TV housing and a remote-control and smartphone holder device including a television housing; and at least one remote control holder and a cell phone holder. The device is a one-piece device. The device is made by injection molding.

### BRIEF DESCRIPTION OF THE DRAWINGS

The invention will be further described by way of example, with reference to the accompanying drawings, in which:

FIG. 1 is a perspective view of a one-piece combination of a TV housing and a remote-control and smartphone holder according to an embodiment of the present invention showing one holder for holding a remote control and a smartphone;

FIG. 2 is a top view of the one-piece combination of a TV housing with a remote-control and smartphone holder of FIG. 1;

FIG. 3 is a front view of the one-piece combination of a TV housing with a remote-control and smartphone holder of FIG. 1;

FIG. 4 is a side view of the one-piece combination of a TV housing with a remote-control and smartphone holder of FIG. 1;

FIG. 5 is a back view of the one-piece combination of a TV housing with a remote-control and smartphone holder of FIG. 1;

FIG. 6 is a perspective view of a one-piece combination of a TV housing with a remote-control and smartphone holder according to an embodiment of the present invention showing one holder for holding a remote control on one side of the TV housing and a second holder for holding a smartphone on the other side;

FIG. 7 is a top view of the one-piece combination of a TV housing with a remote-control and smartphone holder of FIG. 6;

FIG. 8 is a front view of the one-piece combination of a TV housing with a remote-control and smartphone holder of FIG. 6;

FIG. 9 is a side view of the one-piece combination of a TV housing with a remote-control and smartphone holder of FIG. 6;

FIG. 10 is a back view of the one-piece combination of a TV housing with a remote-control and smartphone holder of FIG. 6;

FIG. 11 is a perspective view of a one-piece combination of a TV housing with a remote-control and smartphone holder according to an embodiment of the present invention showing one holder for holding a remote control and/or a smartphone on the bottom part of the TV housing;

FIG. 12 is a top view of the one-piece combination of a TV housing with a remote-control and smartphone holder of FIG. 11;

FIG. 13 is a front view of the one-piece combination of a TV housing with a remote-control and smartphone holder of FIG. 11;

FIG. 14 is a side view of the one-piece combination of a TV housing with a remote-control and smartphone holder of FIG. 11;

FIG. 15 is a back view of the one-piece combination of a TV housing with a remote-control and smartphone holder of FIG. 11;

FIG. 16 is a perspective view of a one-piece combination of a TV housing with a remote-control and smartphone holder according to an embodiment of the present invention showing one compartment for holding a remote control and a smartphone on the top part of the TV housing;

FIG. 17 is a top view of the one-piece combination of a TV housing with a remote-control and smartphone holder of FIG. 11;

FIG. 18 is a front view of the one-piece combination of a TV housing with a remote-control and smartphone holder of FIG. 11;

FIG. 19 is a side view of the one-piece combination of a TV housing with a remote-control and smartphone holder of FIG. 11;

FIG. 20 is a back view of the one-piece combination of a TV housing with a remote-control and smartphone holder of FIG. 11;

FIG. 21 is a front view of a one-piece combination of a TV housing with a remote-control and smartphone holder according to an embodiment of the present invention showing two holders for holding a remote control and/or a smartphone on the top part of the TV housing;

FIG. 22 is a front view of a one-piece combination of a TV housing with a remote-control and smartphone holder according to an embodiment of the present invention showing two compartments for holding a remote control and a smartphone on the side of the TV housing;

FIG. 23 is a front view of a one-piece combination of a TV housing with a remote-control and smartphone holder according to an embodiment of the present invention showing two compartments for holding a remote control and a smartphone on the bottom part of the TV housing;

FIG. 24 is a front view of a one-piece combination of a TV housing with a remote-control and smartphone holder according to an embodiment of the present invention;

FIG. 25 is a front view of a one-piece combination of a TV housing with a remote-control and smartphone holder according to an embodiment of the present invention;

FIG. 26 is a front view of a one-piece combination of a TV housing with a remote-control and smartphone holder according to an embodiment of the present invention;

FIG. 27 is a front view of a one-piece combination of a TV housing with a remote-control and smartphone holder according to an embodiment of the present invention;

FIG. 28 is a front view of a one-piece combination of a TV housing with a remote-control and smartphone holder according to an embodiment of the present invention; and

FIG. 29 is a front view of a combination of a one-piece TV housing with a remote-control and smartphone holder according to an embodiment of the present invention.

### DESCRIPTION OF THE PREFERRED EMBODIMENTS

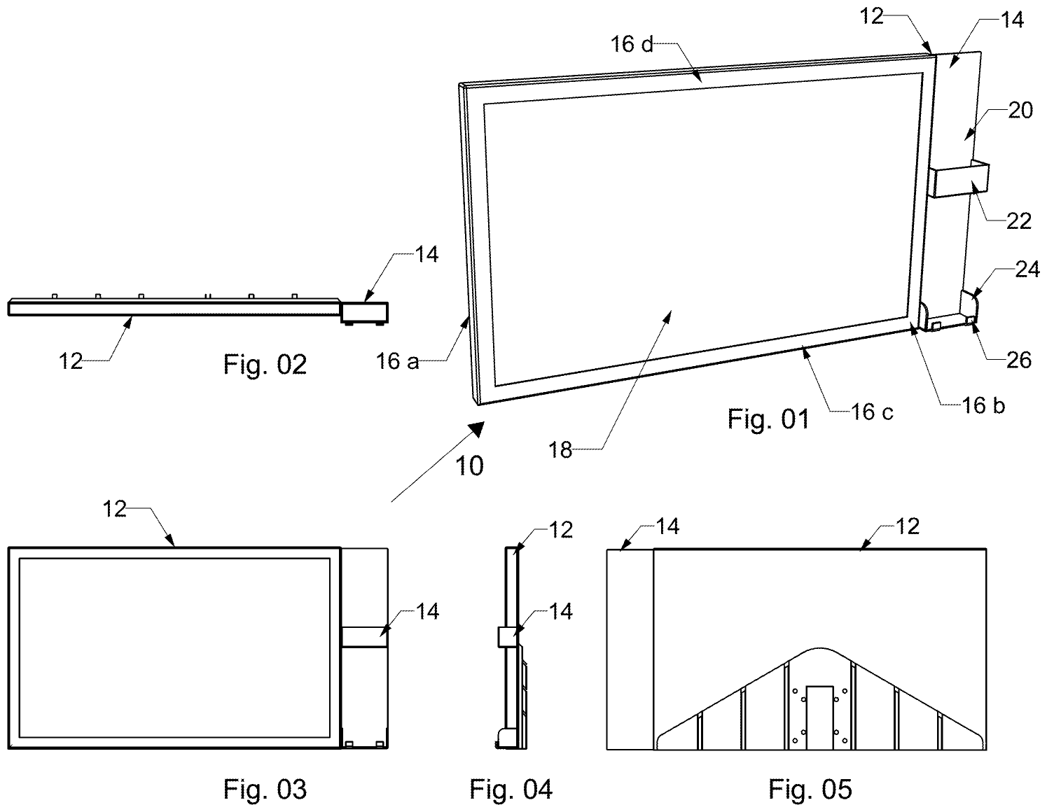

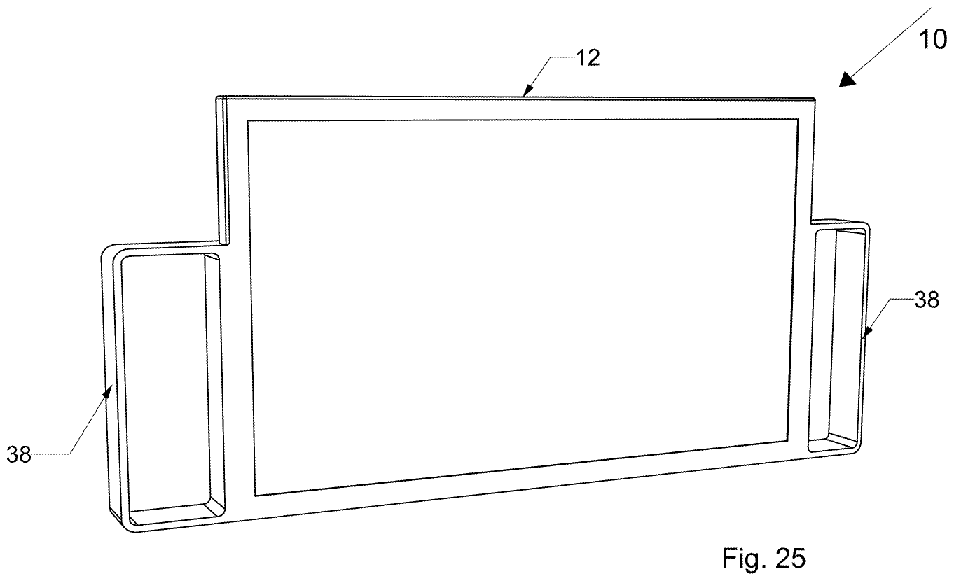

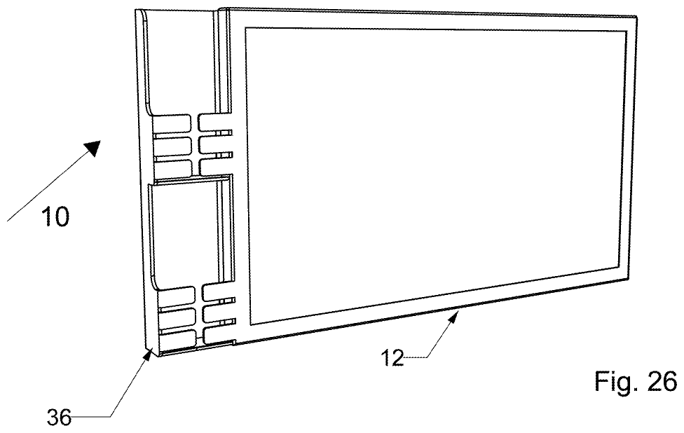

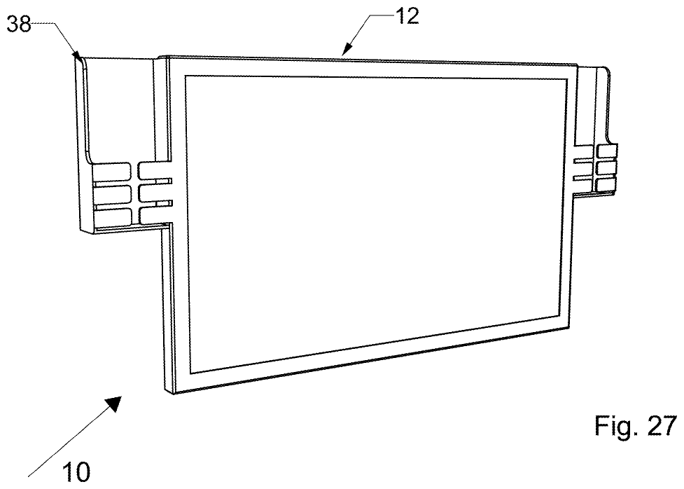

FIGS. 1-29 show a TV set generally indicated by the reference numeral 10. It will be understood that for purposes of the present invention, reference will be made to a television set, although it will become clear that any other electronic or electrical device can be used, such as computer monitors, VCR, baby monitors, stereo, or the like.

FIGS. 1-29 show a one-piece combination of a TV housing with a remote-control and smartphone holder 10 according to the present invention. The one-piece combination 10 includes a TV housing 12 having integrated a remote-control and a smartphone holder 14.

The one-piece combination 10 is a unitary piece constructed from a variety of materials. In some embodiments, the one-piece combination 10 is made from a material comprising at least one plastic. The one-piece combination 10 preferably made by using the injection-molding method. This is a very important advantage of the present invention since it can be readily mass-produced by a conventional plastic injection process.

In some embodiments, the TV housing 12 may be a computer housing or a monitor. The housing may be between 12 to 80 inches long, preferably between 12-35 inches long.

The TV housing 12 is of conventional construction including a left side wall 16a, a right-side wall 16b, a bottom side wall 16c, a top side wall 16d that together form a generally rectangular housing surrounding a central screen viewing area 18. The TV housing 12 may be constructed in a variety of sizes to accommodate various standard sizes for televisions.

The remote-control and smartphone holder 14 is integrated into the TV housing and cannot be removed from it. The remote-control and smartphone holder 14 may be of a size and shape to hold one or various types and sizes of devices (not shown), including, but not limited to, remote control devices or cell phone devices.

In FIGS. 1-5 the one-piece combination of a TV housing with a remote-control and smartphone holder 10 according to an embodiment of the present invention show one holder for holding a remote control and a smartphone. The remote-control and smartphone holder 14 of these figures shows a receiving housing 20 defining a three-dimensional space greater than the three-dimensional space occupied by a remote-control unit and/or and smartphone to be housed within the holder 14. The receiving housing 20 includes an open front face, a horizontal strap 22 on the open front face, side flaps 24 located on the bottom side of side ends of the housing, and front stoppers 26 on bottom side of the open front face, which all together prevent the remote control and/or smartphone from falling from the holder.

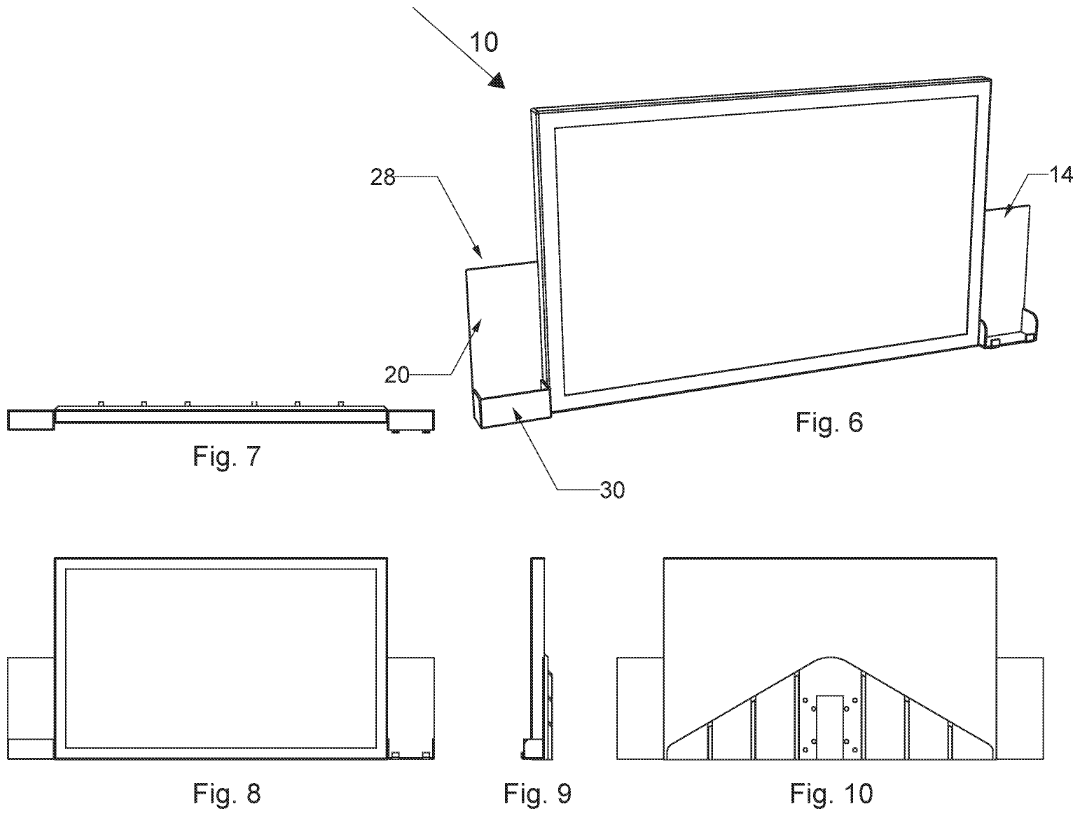

In FIGS. 6-10 the one-piece combination of a TV housing with a remote-control and smartphone holder according to an embodiment of the present invention show one holder for holding a remote control 14 on one side of the TV housing 12 and a second holder for holding a cell phone on the other side 28. The holder for holding the cell phone 28 shows a receiving housing 20 having a raised perimeter at the bottom 30 to prevent the cell phone from falling from the holder.

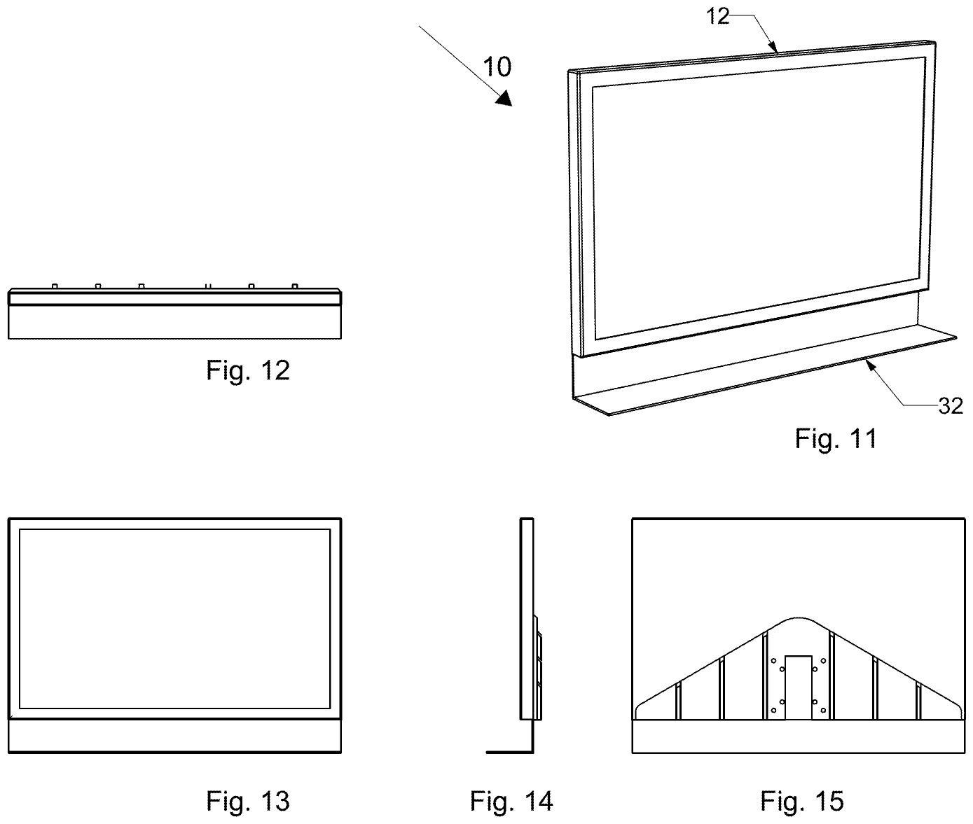

In FIGS. 11-15 the one-piece combination TV housing and a remote-control holder according to an embodiment of the present invention show one holder 32 for holding a remote control and/or a smartphone on the bottom part of the TV housing. The holder has an L-shape.

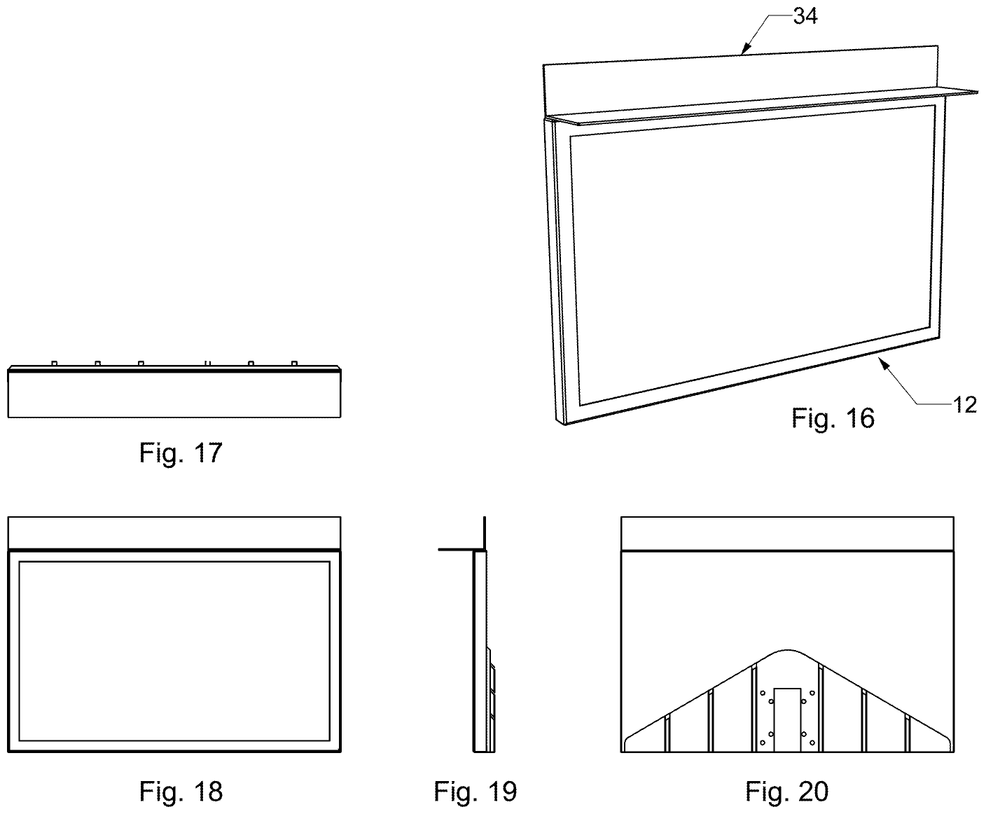

In FIGS. 16-20 the one-piece combination TV housing and a remote-control holder according to an embodiment of the present invention show one holder 34 for holding a remote control and/or a smartphone on the top part of the TV housing. The holder has an L-shape.

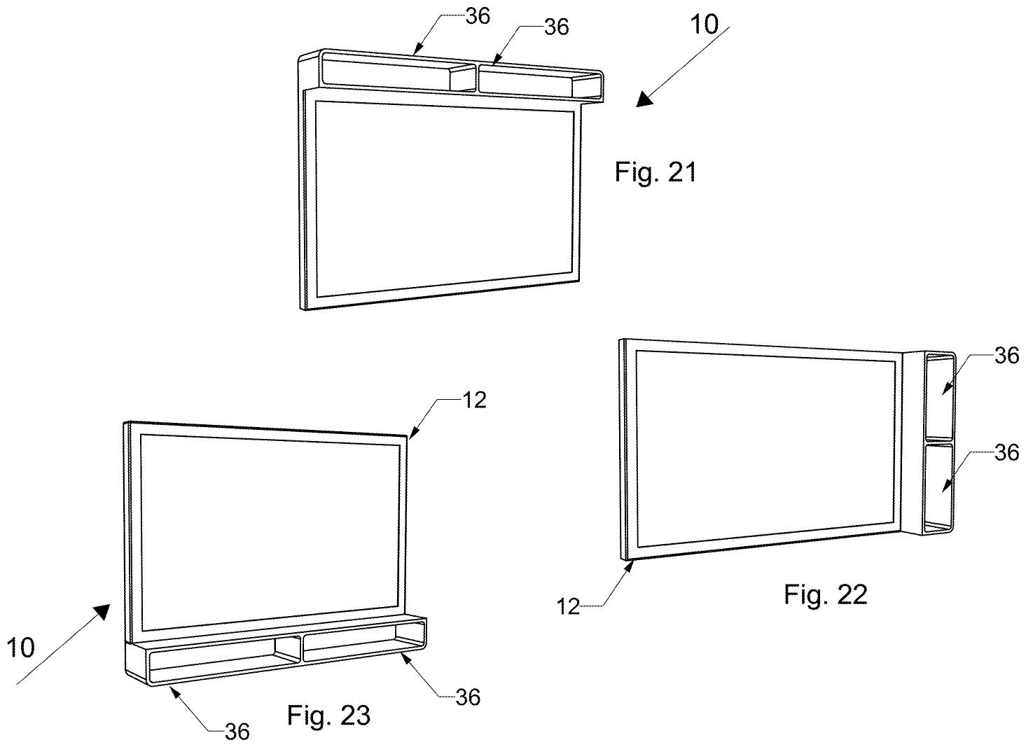

In FIGS. 21-23 the one-piece combination TV housing and a remote-control holder according to an embodiment of the present invention show two holders 36 for holding a remote control and/or a smartphone on the top part, side part, and bottom part, respectively, of the TV housing. The holders have a box shape with one open end.

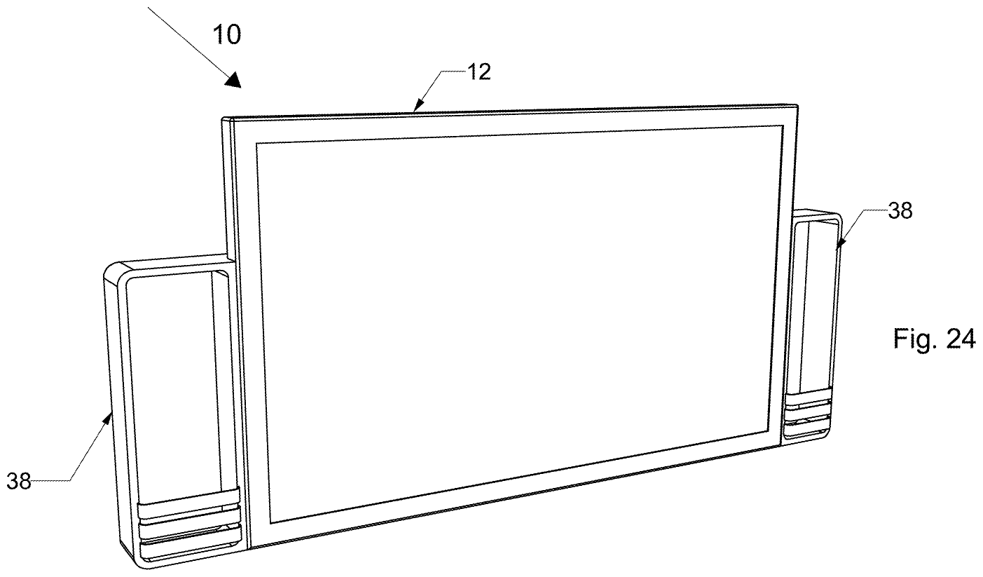

In FIGS. 24-27 the one-piece combination of a TV housing and a remote-control holder according to an embodiment of the present invention show two holders for holding a remote control and/or a smartphone on each side of the TV housing 12.

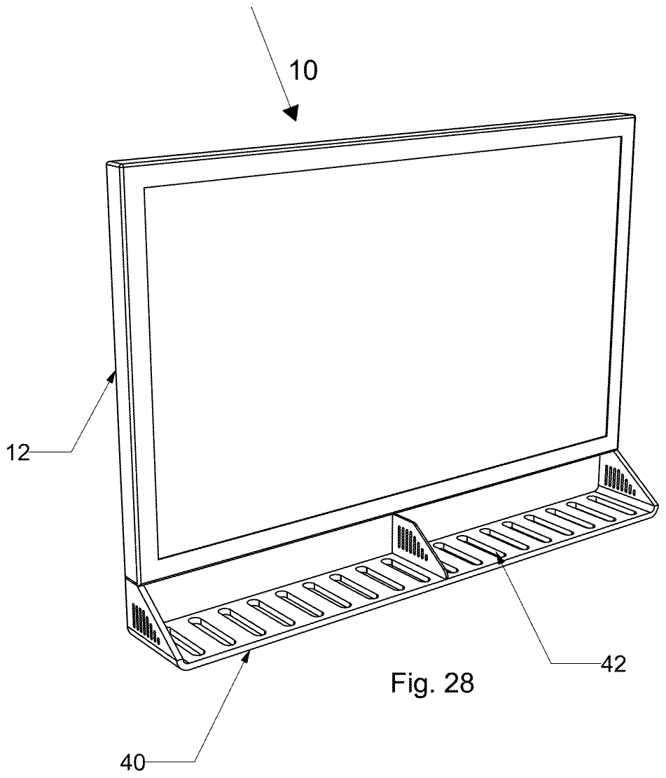

In FIG. 28 the one-piece combination of a TV housing and a remote-control holder according to an embodiment of the present invention shows a holder 40 for holding a remote control and/or a smartphone on the bottom of the TV housing 12. The holder 40 includes a plurality of recess 42 for holding the remote control and/or smartphone in an upright position.

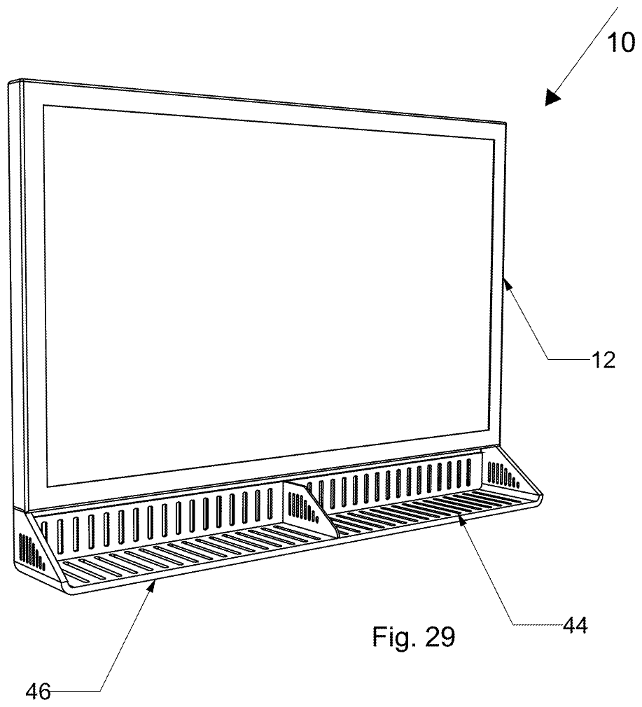

In FIG. 29 the one-piece combination of a TV housing with a remote-control and smartphone holder according to an embodiment of the present invention shows a holder 44 for holding a remote control and/or a smartphone on the bottom of the TV housing 12.

The holder 44 has an L-shape and includes a plurality of recess 42 for holding the remote control and/or smartphone in an upright position.

The present invention prevents the misplacement of the remote control and/or smartphone. In addition, the one-piece design will not allow damage to the TV housing and/or change the appearance of the room.

1. A combination of a TV housing with a remote-control holder and a smartphone holder device comprising:
a television housing; and
at least one of a remote-control holder and a smartphone holder;
wherein the at least one of a remote-control holder and the smartphone holder are integrated into the television housing forming a one-piece device.

2. A combination of a TV housing with a remote control and smartphone holder device comprising:
a television housing; and
at least one of a remote-control holder and a smartphone holder;
wherein the at least one of a remote-control holder and the smartphone holder are integrated into the television housing forming a one-piece device;
wherein the device is made by injection molding.

3. The combination according to claim 1, wherein the device includes one remote-control holder or one smartphone holder.

4. The combination according to claim 1, wherein the device includes one remote-control holder and one smartphone holder.

5. The combination according to claim 1, wherein the remote-control holder or the smartphone holder has an L-shape and includes a plurality of recess.

6. The combination according to claim 1, wherein the remote-control holder or the smartphone holder includes a housing defining a three-dimensional space with an open front face, a horizontal strap on the open front face, side flaps located on bottom side of side ends of the television housing, and front stoppers on the bottom side of the open front face.

7. The combination according to claim 1, wherein the remote-control holder or the smartphone holder has an L-shape.

8. The combination according to claim 1, wherein the remote-control holder or the smartphone holder has a box shape with one open end.

9. The combination according to claim 1, wherein the device includes at least two remote control holders.
